(19) United States
(12) Patent Application Publication
(10) Pub. No.: US 2014/0280274 A1
(43) Pub. Date: Sep. 18, 2014

(54) PROBABILISTIC RECORD LINKING

(71) Applicant: Teradata US, Inc., Dayton, OH (US)

(72) Inventors: Anand Louis, Bangalore (IN); Shashank Saket, Kuala Lumpur (MY)

(73) Assignee: Teradata US, Inc., Dayton, OH (US)

(21) Appl. No.: 14/177,702

(22) Filed: Feb. 11, 2014

Related U.S. Application Data
(60) Provisional application No. 61/788,665, filed on Mar. 15, 2013.

(51) Int. Cl. G06F 17/30

(52) U.S. Cl. CPC G06F 17/30595
USPC 707/758

(57) ABSTRACT

Probabilistic record linking methods and a system are provided. Selections are acquired; the selections identify the two data sources, column identifiers from each of the two data sources, pairs of column identifiers from each of the two data sources, a confidence values for matching each record associated with each pair. The selections are used to compare data housed in the two data sources. Based on the comparison, matched records and non matched records are identified from the two data sources.

### RELATED APPLICATIONS

The present application is co-pending with, claims priority to, and is a non-provisional application of Provisional Application No. 61/788,665 entitled: “Techniques for Probabilistic Record Linking,” filed on Mar. 15, 2013; the disclosure of which is hereby incorporated by reference in its entirety herein and below.

### BACKGROUND

After over two-decades of electronic data automation and the improved ability for capturing data from a variety of communication channels and media, even small enterprises find that the enterprise is processing terabytes of data with regularity. Moreover, mining, analysis, and processing of that data have become extremely complex. The average consumer expects electronic transactions to occur flawlessly and with near instant speed. The enterprise that cannot meet expectations of the consumer is quickly out of business in today's highly competitive environment.

Because of the massive collection of data from a variety of sources, enterprises also face significant integration/interoperability issues. That is, the data and the sources of data are exploding at rates that prevent the enterprise for fully integrating the data. For example, one source of data may have no discernible field or record keys; such that manual inspection of the data becomes a necessity to properly integrate the data with other related data within the enterprise. The data sources that an enterprise is attempting to integrate may be voluminous as well, adding to the manual efforts of the enterprise. Still further, some fields within a data source may lack identifying data or may misidentify data, which also complicates integration tasks.

Information or content, which is derived from the raw data of an enterprise, has become a currency in commerce, where quality and timely information can yield significant revenues and competitive advantages for the enterprise that can deliver such information. To derive information, the raw data has to be properly assimilated and related, such that analytics and other valuable services can be performed to derive and deliver relevant information.

Thus, there is a need to more efficiently and timely assimilate, relate, and organize large amounts of data.

### SUMMARY

In various embodiments, probabilistic record linking methods and a system are presented. According to an embodiment, a method for probabilistic record linking is provided.

Specifically, master column identifiers are mapped to target column identifiers; each mapping identifies a unique pair for a particular master column identifier to a particular target column identifier. Next, a match confidence value and a no-match confidence value are acquired for each mapping pair. Then, each mapping pair with its corresponding master data in a master data source is compared to target data in a target data source using each mapping pair's match confidence value and non-match confidence value. Finally, matched records in a matched pool, non-matched records from the master data source in a non-matched pool, and potential matched records a potential matched are generated pool based on the comparison.

### BRIEF DESCRIPTION OF THE DRAWINGS

FIG. 1 is a diagram of a method for probabilistic record linking, according to an example embodiment.

FIG. 2 is a diagram of another method for probabilistic record linking, according to an example embodiment.

FIG. 3 is a diagram of a probabilistic record linking system, according to an example embodiment.

### DETAILED DESCRIPTION

FIG. 1 is a diagram of a method 100 for probabilistic record linking, according to an example embodiment. The software module(s) that implement the method 100 are herein referred to as “record linker.” The executable instructions of the record linker are programmed in memory and/or non-transitory computer-readable storage medium, which execute on one or more processors (specifically configured to execute the record linker). Moreover, the record linker has access to one or more networks (wired, wireless, or a combination of both wired and wireless).

Initially, it is noted that specific embodiments and sample implementations for various aspects of the invention are provided in detail in the provisional filing (Provisional Application No. 61/788,665), which is incorporated by reference in its entirety herein. The provisional filing also includes a variety of screen shots that illustrate sample screens for the interface discussed herein and below.

In an embodiment, a “data source” is a relational database table having one or more columns and rows. A row that spans multiple columns of a relational database table is referred to as a “record.” Each column and row includes column identifiers and row identifiers, which provides a reference for what is included in each of the rows and columns. A “cell” is a particular row and column combination and includes data (or no data if empty); so, a record is a horizontal collection of cells. The table, columns, rows, and cells can have a variety of other metadata that describes their contents, individually, as a whole, and/or in collections with one another.

As used herein, a “master data source” is a database table that is to have some of its records linked with records from a “target data source.” The “target data source” is a database table that has some records being linked with records of the master data source.

As used herein, “an entity” is a logical piece of information that an enterprise wants to track and/or monitor. So, an entity can represent a customer, an account, and the like. Moreover, it is noted that “an entity” can be a customized grouping of multiple entities and, perhaps, the customized groupings are hierarchically organized.

Enterprise data is electronic data that is collected, indexed, and housed by an enterprise on one of more storage devices for purposes of analysis and providing services to internal and external customers.

It is within this initial and brief context, that the processing of the record linker is now discussed with reference to the FIG. 1.

At 110, the record linker maps master column identifiers for a master data source to target column identifiers for a target data source. Each mapping identifies a unique pair (one column of the master data source and one column of the target data source. The master data source and the target data source already identified for processing. Such identification can occur via an interactive graphical user interface (GUI) that communicates with the record linker (this situation is discussed below in greater detail). In an embodiment, the identification can occur via fully automated mechanisms, such as through an Application Programming Interface (API) of the record linker and the API used by an automated application or service. The column identifiers for both the master data source and the target data source can be identified via a GUI interface and/or an API as well. The mapping itself can also be provided through GUI interaction driven by the user or through automated API interaction.

At 120, the record linker acquires a match confidence value and a non-match confidence value for each record in the mapped pair of columns. This can be acquired via a GUI interface from user-inputted values or from automated API interactions. Each confidence value represents the degree of confidence that is to be assigned for indicating a match or a non match. In an embodiment, each confidence value is a number from 0-100 representing a percent of confidence required to identify a match or a non match.

According to an embodiment, at 121, the record linker assigns score values on ranges associated with a comparison operator to the confidence values (matched confidence values and non matched confidence values). That is, the comparison operator drives ranges of values for the confidence values. These values can be configured based on the comparison operator used in the comparison for a high range that has 100% confidence and a low value of some negative value for 0% confidence.

At 130, the record linker compare each pair with its corresponding master data in the master data source to target data in the target data source using each of the pairs matched confidence value and non match confidence value. Here, the data in the sources for the particular row of the pair of columns are compared with one another and the confidence values are used to indicate whether there is a match or no match.

In an embodiment, at 131, the record linker assigns a user-defined function to assist in processing the comparison. Here, a user can assign the algorithm or application to process when determining the compare. The result of the user-defined function is then compared with the confidence values to determine whether there is a match or no match.

In another case, at 132, the record linker sums a unique score for each record identified for the mapped pairs associated with record (row) to generate a total record score for the pairs of that record. The total record score is then compared to a threshold to determine whether that record is one of the matched records, non-matched records, or potential matched records (discussed at 140 below). For example, if the columns in the master data source are M1, M2, and M2 and the columns in the target data source are T1, T2, and T3 and M1 is mapped to T1, M2 to T2, and M3 to T3; then each pair includes two values for cells M1T1 (value for M1 at row R1 and value for T1 at row R1), M2T2 (value for M2 at row R1 and value for T2 at row R1), and M3T3 (value for M3 at row R1 and value for T3 at tow R1). Each pair mapped pair M1T1, M2T2, and M3T3 has two values to compare (as discussed above) for each record and is assigned a unique score based on the comparison for M1T1=S1M1T1, for M2T2=S2M2T2, and for M3T3=S3M3T3; S1M1T1+S2M2T2+S3M3T3=total record (R1) score (TRS). When the TRS is above or equal to the threshold, the record is a match. When the record is below a threshold by a configured amount, the record is a non match. When the record is below the threshold but not by the configured amount, the record is a potential match.

In an embodiment of 132 and at 133, the record linker uses a bypass threshold to compare with each total record score to determine whether that record (row for the mapped pairs) is one of the potential matched records. Here, the configured below the threshold to identify the non matched records is not used; rather, a potential matched record is identified by its own bypass threshold.

In an embodiment of 133 and at 134, the record linker obtains the bypass threshold from a user via a GUI interface associated with the processing actions of the record linker.

In an embodiment of 134 and at 135, the record linker provides a list of available bypass thresholds to the user for selection within the GUI interface.

At 140, the record linker generates matched records in a matched record pool, non matched records in a non matched pool, and potential matched records in a potential matched pool. So, based on the confidence values and the comparison, each record for the mapped pairs is either linked together (matched pool), identified as potential records for linking (potential matched pool), or identified as not being related at all, such that no link is established (non matched pool). One appreciates that this is a substantial improvement over what has been capable of being accomplished in the industry today because databases can be very large and the desire within the industry to have automated mechanisms to link related records is highly desired. Today, much of the record linking is a manual-intensive task requiring inspecting each record of a potentially merged database.

In an embodiment, at 150, the record linker identifies duplicate records in the master data source in a duplicate pool. Since, the master data source is being processed this can also permit automated cleanup of duplicate master data source records to improve the quality and operational efficiency of the master data source.

In an embodiment of 150 and at 151, the record linker presents the pools with record, column, and source identifiers in a display for visual inspection by a user. This allows the user to readily ascertain what percentage of records are related link, what percentage of records may need further inspection (potentially matched), and what percentage of records are not a match. So, the user can better understand what manual effort might be necessary to clean up the potential matches or what tweaks to the confidence values might be made to improve the matched records by capturing more of the potential matches. The information can be presented in table form, graph form, and/or summary form. The visual inspection may also indicate that some tweaking is needed of the confidence values to reduce the number of matches and, perhaps, increase the number of non matches. This helps the user in an efficient manner to understand the data from potentially two very large data sources (databases). In fact, the processing can be iterative in nature (as discussed below).

According to an embodiment, at 160, the record linker provides user information (security, identities, roles, etc.), status information (processing throughput, error rate, memory load, etc.), and summary metrics (number of users, databases being processed, overall matched/unmatched rates, etc.) that are relevant to the processing actions of the record linker and other instances of the record linker on the network to a dashboard service accessible to an administrator. So, the entire network processing multiple databases by multiple users accessing instances of the record linker can be centrally monitored in real time for management and maintenance relevant to the record linker and the database processing environments on the network.

In an embodiment, at 170, the record linker provides the processing for the mapping (110) and acquiring (120) relevant to the record linker as a GUI to the user to provide the selections. So, the record linker can include a GUI to interact with a user and underlying processing to link relevant records between data sources and identify non relevant records or potentially relevant records.

As a further illustration of the record linker using the same nomenclature presented above at 132, the following example set of data and processing is provided.

Consider a master data source M as follows:

| M1 (name) | M2 (address) | M3 (phone) |
|---|---|---|
| Anand | Add1 | phone1 |
| Louis | Add2 | phone2 |
| James | Add3 | phone3 |

Consider a target data source T as follows:

| T1 (customer) | T2 (home) | T3 (number) |
|---|---|---|
| Anand | Add1 | phone1 |
| Louis | Add4 | phone2 |
| Ryan | Add5 | phone5 |

A user accesses a GUI that it interfaced to the record linker and identifies, initially, M1 and T1. Then, the user associates in the GUI pairs as M1T1, M2T2, and M3T3 and assigns a matched confidence value of 3 to M1T1 and a non matched confidence value of −1 to M1T1; a matched confidence value of 4 to M2T2 and a non matched confidence value of −6 to M2T2; and a matched confidence value of 5 to M3T3 and a non matched confidence value of −4 to M3T3. (Note that the confidence values may be provided as percentages by the user from 0-100, where the scores are generated based on a comparison operator of “equal to” that is normalized to produce values within a defined range.) Assume further that a threshold value of 8 and a bypass threshold value of 2 is either identified for the user or selected by default based on the score ranges.

The record linker iterates M and T to check each record for the columns M1-M3 and T1-T3. The first pair M1T1 of the first record compares “Anand” to “Anand” and produces a score of 3; the next pair M2T2 of the first record compares “Add1” to “Add1” and produces 4. The third pair M2T3 of the first record compares “phone1” to “phone1” and produces a score of 5. The sum for the first record is 12 (3+4+5) and 12 is above the threshold value of 8 so the first record is linked (meaning the first row in M for columns M1-M3 are linked to the first row of T for columns T1-T3 to produce a linked record).

The record linker then compares the second record for the first pair M1T1 (“Louis” compared with “Louis) producing a score of 3. The second pair is then compared M2T2 (“Add2” compared with “Add4”) producing a score of −6. The third pair is then compared M3T3 (“phone2” compared with “phone2”) producing a score of 5. The sum for the second record is 2 (2−6+5), which is at the bypass threshold value of 2; so, the second row in M for columns M1-M3 are identified as being a potential match with the second row of T for columns T1-T3.

The record linker then compares the third record for the first pair M1T1 (“James” compared with “Ryan”) producing a score of −1. The second pair is then compared M2T2 (“Add3” compared with “Add5”) producing a score of −4. The third pair is then compared M3T3 (“phone3” compared with “phone5” producing a score of −6. The sum for the third record is −11 (−1−4−6), which is below the bypass threshold value of 2; so, the third row in M for columns M1-M3 are identified as a non match with the second row of T for columns T1-T3.

FIG. 2 is a diagram of another method 200 for probabilistic record linking, according to an example embodiment. The software module(s) that implement the method 200 are herein referred to as “probability linker.” The executable instructions of the probability linker are programmed in memory and/or non-transitory computer-readable storage medium, which execute on one or more processors (specifically configured to execute the probability linker). Moreover, the probability linker has access to one or more networks (wired, wireless, or a combination of both wired and wireless).

The probability linker presents another, and perhaps, enhanced processing perspective record linker, presented above with respect to the FIG. 1.

At 210, the probability linker receives selections from an interface for two data sources, column identifiers, pairs of column identifiers, and confidence values for matching each record associated with the pairs. This was discussed at length above with reference to the FIG. 1.

At 220, the probability linker compares records from the two data sources based on the selections. That is, the probability linker takes the selections as input to configure itself for processing the rows of the two data sources. This was also discussed at length above with reference to the FIG. 1.

According to an embodiment, at 221, the probability linker obtains a reference to a user-defined function from the interface. The user-defined interface processed to provide input to the processing associated with the comparison at 220. Here, the user can control the algorithm that assists in performing the compare (as discussed above with reference to the FIG. 1).

At 230, the probability linker provides to the interface a matched list of matched records and a non-matched list of non-matched records based on the comparison of 220. Mechanisms for achieving this were discussed above with reference to the FIG. 1.

According to an embodiment, at 231, the probability linker receives adjustments (modifications) to the confidence values from the interface and iterates the processing of 210-230 for a second iteration based on the adjustments. In this manner, the probability linker is interactive and iterative permitting a user to iteratively achieve the best record linking configuration for the two data sources.

In an embodiment, at 240, the probability linker provides to the interface a duplicate list of records identified in at least one of the two databases. This is another automated technique to improve the size, access efficiency, and quality of the databases while finding relevant records in the two databases for record linking.

In an embodiment, at 250, the probability linker provides a potential list of potential matched records based on the comparison. This scenario was also discussed above with reference to the FIG. 1.

FIG. 3 is a diagram of a probabilistic record linking system 300, according to an example embodiment. The components of the probabilistic record linking system 300 are implemented as one or more software modules having executable instructions that are programmed within memory and/or non-transitory computer-readable storage media and that execute on one or more processing nodes (processors) of a network. Furthermore, the probabilistic record linking system 300 has access to one or more networks. The network is wired, wireless, or a combination of both wired and wireless.

The probabilistic record linking system 300 implements, inter alia, the methods 100 and 200 of the FIGS. 1 and 2.

The probabilistic record linking system 300 includes at least one processor 301, record linking module 302, and, optionally, an interface module 303.

The processor(s) 301 have access to memory and/or non-transitory computer-readable storage media to execute the record module 302 and the interface module 303.

The record linking module 302 includes executable instructions programmed and residing in the memory and/or the non-transitory computer-readable storage medium. The executable instructions execute on the at least one processor 301. In an embodiment, the record linking module 302 is the record linker of the FIG. 1 and/or the probability linker of the FIG. 2.

The record linking module 302 is operable to (configured or adapted to) i) execute on at least one of the processors 301; ii) receive selections that identify: at least two databases, column identifiers for the at least two databases, pairs of column identifiers for the at least two databases, and confidence values for matching each pair; iii) compare the at least two databases based on the selections; and iv) generate matching records and non matching records based on the comparison. Each of these actions i-iv were discussed at length above with reference to the FIGS. 1-2.

According to an embodiment, the probabilistic record linker module 302 is further operable to (adapted to or configured to): v) generate potential matching records based on the comparison and vi) generate duplicate records identified from at least one of the at least two databases.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

1. A method, comprising:
mapping, by a processor, master column identifiers to target column identifiers, each mapping identifying a unique pair for a particular master column identifier to a particular target column identifier;
acquiring, by the processor, a match confidence value and a no-match confidence value for each mapping pair;
comparing, by the processor, each mapping pair with its corresponding master data in a master data source to target data in a target data source using each mapping pair's match confidence value and non-match confidence value; and
generating, by the processor, matched records in a matched pool, non-matched records from the master data source in a non-matched pool, and potential matched records a potential matched pool based on the comparison.

2. The method of claim 1 further comprising, identifying, by the processor, duplicate records in the master data source in a duplicate pool.

3. The method of claim 2 further comprising, presenting, by the processor, the pools with record, column, and source identifiers in a display associated with the processor.

4. The method of claim 1 further comprising, providing, by the processor, user information, status information, and summary metrics relevant to the processing to a dashboard service accessible to an administrator.

5. The method of claim 1 further comprising, providing, by the processor the mapping and acquiring processing as a graphical user interface to a user to provide selections.

6. The method of claim 1, wherein acquiring further includes assigning score values based on ranges associated with a comparison operator to the matched confidence values and the non-matched confidence values.

7. The method of claim 1, wherein comparing further includes assigning a user-defined function to assist in processing the comparison.

8. The method of claim 1, wherein comparing further includes assigning an “equal to” operator as a default comparison operator when no user-defined function for the comparison is detected.

9. The method of claim 1, wherein comparing further includes summing a unique score for each record identified for those pairs associated with that record to generate a total record score that is compared to a threshold to determine whether that record is one of: the matched records, the unmatched records, the potential matched records.

10. The method of claim 9, wherein summing further includes using a bypass threshold with the threshold to compare with the total record score to determine whether that record is one of the potential matched records.

11. The method of claim 10, wherein using further includes obtaining the bypass threshold from a user via an interface associated with the processing.

12. The method of claim 11, wherein obtaining further includes providing a list of available bypass thresholds to the user for selection within the interface.

13. A method, comprising:
receiving, by a processor, selections from an interface, the selections for: two data sources, column identifiers, pairs of column identifiers, and confidence values for matching each record associated with the pairs;
comparing, by the processor, records from the two data sources based on the selections; and
providing, by the processor, to the interface a matched list of matched records and a non-matched list of non-matched records based on the comparison.

14. The method of claim 13 further comprising, providing, by the processor, to the interface a duplicate list of duplicate records identified in at least one of the two data sources.

15. The method of claim 13 further comprising, providing, by the processor, a potential list of potential matched records based on the comparison.

16. The method of claim 13, wherein comparing further includes obtaining a reference to a user-defined function from the interface, the user-defined function processed to provide input to the comparison.

17. The method of claim 13, wherein providing further includes receiving adjustments to the confidence values from the interface and iterating the processing for a second iteration based on the adjustments.

18. A system, comprising:
a processor having a record linking module; and
the record linking module, the record linking module operable to (i) execute on the processor; (ii) receive selections that identify: two databases, column identifiers from each of the two databases, pairs of column identifiers for each of the two databases, and confidence values for matching each pair; and (iii) compare the two databases based on the selections; and (iv) generate matching records and non matching records based on the comparison.

19. The system of claim 18 further comprising, an interface module, the interface module operable to (i) execute on the processor; (ii) interact with a user to receive the selections; (iii) interact with the record linking module to receive the matching records and the non matching records; and (iv) present the matching records and the non matching records as lists within a screen of a display associated with a device of the user.

20. The system of claim 19, wherein record linking module is further operable to: (v) generate potential matching records based on the comparison and (vi) generate duplicate records identified from at least one of the two databases.
